(19) United States
(12) Patent Application Publication
(10) Pub. No.: US 2026/0186162 A1
(43) Pub. Date: Jul. 2, 2026

(54) MACHINE LEARNING BASED AUTOMATIC MARKER SEPARATION

(71) Applicant: SCHLUMBERGER TECHNOLOGY CORPORATION, Sugar Land, TX (US)

(72) Inventors: Atul Laxman KATOLE, Houston, TX (US); Aria ABUBAKAR, Houston, TX (US); Edo HOEKSTRA, Stavanger (NO); Srikanth RYALI, Houston, TX (US); Tao ZHAO, Houston, TX (US)

(21) Appl. No.: 19/131,949

(22) PCT Filed: Nov. 21, 2023
(86) PCT No.: PCT/US2023/080711

§ 371 Date: May 22, 2025

Related U.S. Application Data
(60) Provisional application No. 63/384,659, filed on Nov. 22, 2022.

(51) Int. Cl. G01V 1/50

(52) U.S. Cl. CPC G01V 1/50; G01V 2210/6169; G01V 2210/74

(57) ABSTRACT

In one embodiment, a method directed to automatically separating geological markers associated with well log data includes receiving well log data captured by one or more sensors disposed within a wellbore of a well. The method further includes generating clusters of one or more geological markers associated with the well log data. The method further includes executing one or more of: initiating generation of a visualization of the clustered one or more geological markers on a display device such that the visualization indicates space-time structural transitions of a geological formation associated with a well; mapping and correlating facies data that indicate sedimentary structure data, fossil data, or geological associations of the geological formation; determining geological trap data that indicate a sealed geologic container of the geological formation that holds fluid and is associated with the well; or projecting reservoir trends of a reservoir to which the well is connected.

### CROSS-REFERENCE TO RELATED APPLICATIONS

This application claims priority to U.S. Provisional Patent App. No. 63/384,659, filed on Nov. 22, 2022, and titled “Machine Learning Based Automatic Marker Separation,” which is incorporated herein by reference in its entirety for all purposes.

### INTRODUCTION

This disclosure relates to machine learning based automatic marker separation operations associated with well log data.

### BACKGROUND

As the number of wells grow to hundreds and thousands in a given basin, there is a need for selecting a plurality of geological markers that characterize a plurality of marked depths of a well that can be visualized for further analysis. The names provided to geological markers by distinct energy development teams may be sometimes different thereby compounding problems associated with the next steps of identifying geological markers associated with multiple well logs in a consistent manner. For example, inconsistencies in the naming and/or reporting and/or visualization operations associated with geological markers for multiple well logs often lead to incorrect correlation of layer boundaries across multiple wells and thereby negatively impacting energy development operations for a given resource site.

There is therefore a need to address the above-noted challenges associated with well log data management.

### SUMMARY

Disclosed are methods, systems, and computer programs that automatically separate geological markers associated with well log data. According to an embodiment, a method for automatically separating geological markers associated with well log data comprises: receiving well log data captured by one or more sensors disposed or deployed within a wellbore of a well at a resource site; and generating a marker time series window for the well log data, the marker time series window being applied to select one or more data samples within the well log data to generate a first windowed dataset of the well log data.

The method further includes masking one or more data elements of the first windowed dataset of the well log data to generate a masked windowed dataset, such that the one or more data elements of the first windowed dataset comprise data elements in a first dimension; and configuring a transformer model using the masked windowed dataset of the well log data.

In response to generating encoder output data based on applying a second windowed dataset to the data encoder of the transformer model, the method includes executing a minimization operation on the encoder output data to generate minimized data in a second dimension.

The method also includes automatically executing a clustering operation on the minimized data, the clustering operation including aggregating together, one or more geological markers comprised in the plurality of geological markers.

In other embodiments, a system and a computer program can include or execute the method described above. These and other implementations may each optionally include one or more of the following features.

The transformer model, according to some embodiments, includes at least one of: a data encoder that receives the masked windowed dataset of the well log data; and a data decoder that translates outputs of the data encoder into estimated values of the one or data elements.

In one embodiment, the geological parameters include one or more of: gamma ray data associated with the well at the resource site; resistivity data associated with the well at the resource site; density or porosity data associated with the well at the resource site; water saturation data associated with the well at the resource site; and hydrocarbon saturation data associated with the well at the resource site.

Furthermore, the encoder output data comprises a latent representation of the masked windowed dataset of the well log data according to some implementations.

In exemplary cases, the marker time series window is selected based on geological properties of the geological formation associated with the well.

Moreover, the minimizing operation referenced above may be executed using a cosine distance measure process that computes a distance between features of the data elements associated with the one or more geological markers.

Furthermore, the geological trap data, according to one embodiment, comprises one of: structural trap data; or stratigraphic trap data.

In addition, the one or more geological markers that are aggregated together have similar geological properties.

Exemplary implementations of the above method may further include: applying as input to the data encoder of the transformer model, a plurality of windowed datasets from a plurality of well log data associated with a plurality of wells to generate a plurality of encoder output data; executing a plurality of minimization operations on the plurality of encoder output data to generate a plurality of minimized data; automatically executing a clustering operation on the plurality of minimized data, the clustering operation including aggregating together a plurality of geological markers: associated with the plurality of minimized data, and that have similar geological properties. The method also includes executing, using the plurality of geological markers, one or more of: initiating generation of a second visualization of the clustered plurality of geological markers on a display device for viewing by a user, the second visualization indicating space-time structural transitions of one or more geological formations associated with a plurality of wells; mapping and correlating facies data that indicate sedimentary structure data, fossil data, and geological associations of the one or more geological formations associated with the plurality of wells; determining geological trap data that indicate one or more sealed geologic containers of the one or more geological formations that hold fluid and are associated with the plurality of wells; or projecting reservoir trends of one or more reservoirs to which the plurality of wells are connected.

In one embodiment, the one or more data samples of the well log data is represented in an index indicating one or more of: a sample number index; a measured depth index; a true vertical depth subsea index; a true stratigraphic depth index; a two way time index; an index associated with the wellbore; or an index associated with a subsurface geometry model.

In some embodiments, the well log data includes measurements indicating one or more geological parameters.

In addition, configuring the transformer model using the masked windowed dataset of the well log data comprises: applying as input to a data encoder of the transformer model the masked windowed dataset; and predicting at least one data value associated with the masked windowed dataset using the transformer model.

Furthermore, the second dimension is of a lower order relative to a third dimension of the second windowed dataset while the minimized data includes a plurality of geological markers.

In exemplary implementations, the above method further includes executing, based on the clustered one or more geological markers, one or more of: initiating generation of a first visualization of the clustered one or more geological markers on a display device for viewing by a user, the first visualization indicating space-time structural transitions of a geological formation associated with the well; mapping and correlating facies data that indicate sedimentary structure data, fossil data, or geological associations of the geological formation associated with the well; determining geological trap data that indicate a sealed geologic container of the geological formation that holds fluid and is associated with the well; or projecting reservoir trends of a reservoir to which the well is connected.

### BRIEF DESCRIPTION OF THE DRAWINGS

The disclosure is illustrated by way of example, and not by way of limitation in the figures of the accompanying drawings in which like reference numerals are used to refer to similar elements. It is emphasized that various features may not be drawn to scale and the dimensions of various features may be arbitrarily increased or reduced for clarity of discussion. Further, it is contemplated that features of one or more embodiments may be incorporated in other embodiments without additional recitation.

FIG. 1 depicts a high-level flowchart for automatically separating geological markers associated with well log data, according to an embodiment.

FIG. 2 depicts a cross-sectional view of a resource site for which the process of FIG. 1 may be executed, according to an embodiment.

FIG. 3 depicts a network system indicating a communicative coupling of devices or systems associated with the resource site of FIG. 2, according to an embodiment.

FIGS. 4A and 4B provide exemplary visualizations of clustered geological markers according to an embodiment.

FIG. 5 provides an exemplary data flow where a marker time series window is applied to well log data, according to an embodiment.

FIG. 6 provides an exemplary data flow for configuring a transformer model according to an embodiment.

FIG. 7 provides time series representative signatures for a first dataset, according to an embodiment.

FIG. 8 depicts automatic clustering of the set of markers from the exemplary dataset of FIG. 7, according to an embodiment.

FIG. 9 provides time series representative signatures for a second dataset, according to an embodiment.

FIG. 10 depicts automatic clustering of the set of markers from the exemplary dataset of FIG. 9, according to an embodiment.

FIG. 11 depicts a detailed flowchart for automatically separating geological markers associated with well log data, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits and networks have not been described in detail so as not to unnecessarily obscure aspects of the embodiments.

The disclosed systems and methods may be accomplished using interconnected devices and systems that obtain a plurality of data associated with various parameters of interest at a resource site. The workflows/flowcharts described in this disclosure, according to some embodiments, implicate a new processing approach (e.g., hardware, special purpose processors, and specially programmed general-purpose processors) because such analyses are too complex and cannot be done by a person in the time available or at all. Thus, the described systems and methods are directed to tangible implementations or solutions to specific technological problems in exploring natural resources such as oil, gas, water well industries, and other mineral exploration operations. More specifically, the systems and methods presently disclosed may be applicable to exploring resources such as oil, natural gas, water, and Salar brines.

Attention is now directed to methods, techniques, infrastructure, and workflows for operations that may be carried out at a resource site. Some operations in the processing procedures, methods, techniques, and workflows disclosed herein may be combined while the order of some operations may be changed. Some embodiments include an iterative refinement of one or more data associated with the resource site via feedback loops executed by one or more computing device processors and/or through other control devices/mechanisms that make determinations regarding whether a given action, template, transformer model, or other resource data, etc., is sufficiently accurate.

### Overview

Well logs (e.g., data captured in a borehole of a well) comprise data captured using sensor(s) deployed about a borehole penetrating a geological formation. These logs can record petrophysical properties using a variety of sensors that record or measure, for example, gamma ray data, resistivity data, density data, etc., indicating properties of geological structures (e.g., rocks, sand, etc.) and/or fluids associated with the borehole. Depth data comprised in the well logs where there is a change in geological layers of the borehole may be marked or otherwise identified within the well logs. These marked depths may be referred to as well tops or well markers or in some cases, geological markers.

### Example High-Level Flowchart for Automatically Separating Geological Markers

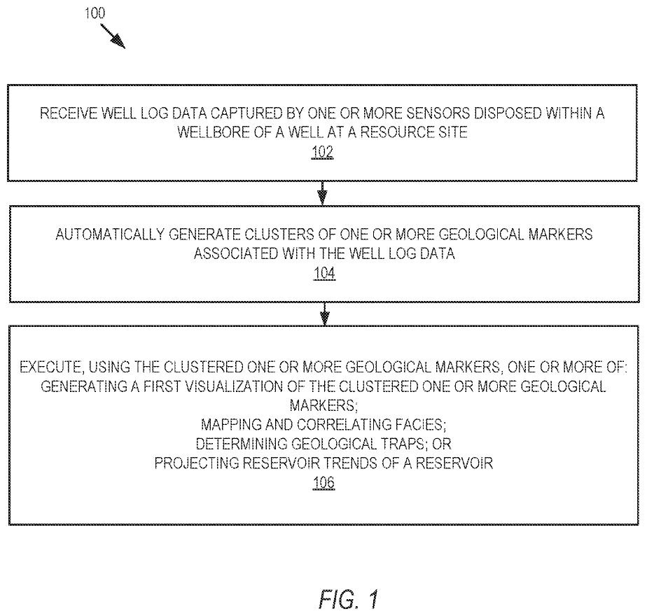

FIG. 1 shows a high-level flowchart 100 for automatically separating geological markers associated with well log data.

At block 102, a signal processing engine may receive well log data captured by one or more sensors disposed within a wellbore of a well at a resource site.

At block 104, the signal processing engine may be used to automatically generate clusters of one or more geological markers associated with the well log data. The automatic clustering generation may include a cosine distance measure that can be implemented to compute the distance between lower dimensional features.

At block 106, the signal processing engine may be further used to execute one or more of: initiating generation of a visualization of the clustered one or more geological markers on a display device for viewing by a user such that the visualization indicates space-time structural transitions of a geological formation associated with a well; mapping and correlating facies data that indicate sedimentary structure data, fossil data, or geological associations of the geological formation associated with the well; determining geological trap data that indicate a sealed geologic container of the geological formation that holds fluid and is associated with the well; or projecting reservoir trends of a reservoir to which the well is connected.

### Resource Site

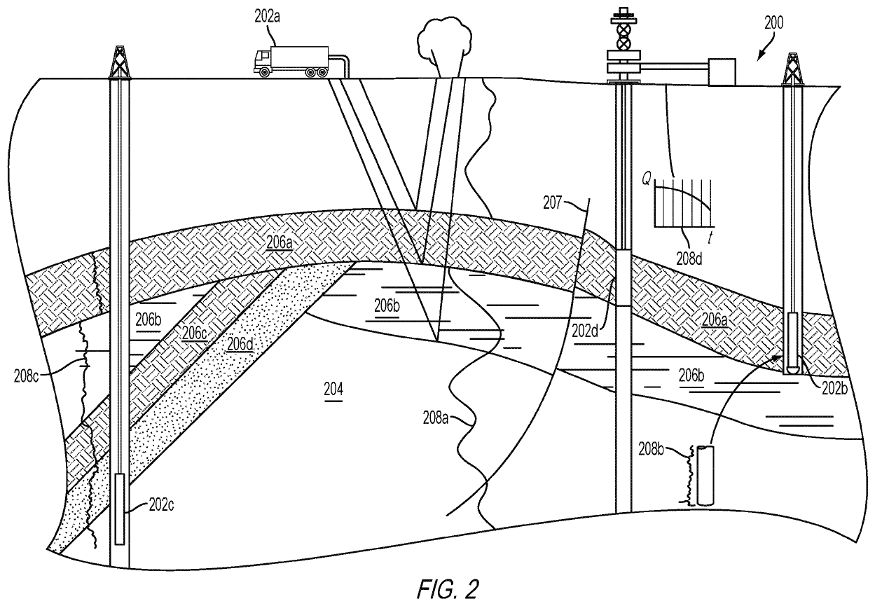

FIG. 2 shows a cross-sectional view of a resource site 200 for which the process of FIG. 1 may be executed. While the illustrated resource site 200 represents a subterranean formation, the resource site, according to some embodiments, may be below water bodies such as oceans, seas, lakes, ponds, wetlands, rivers, etc. According to one embodiment, various measurement tools capable of sensing one or more parameters such as seismic two-way travel time, density, resistivity, production rate, etc., of a subterranean formation and/or geological formations may be provided at the resource site. As an example, wireline tools may be used to obtain measurement information related to geological attributes (e.g., geological attribute data of a wellbore and/or reservoir) including geophysical and/or geochemical information associated with the resource site 200. In some embodiments, various sensors may be located at various locations around the resource site 200 to monitor and collect data for executing the process of FIG. 1.

Part, or all, of the resource site 200 may be on land, on water, or below water. In addition, while a resource site 200 is depicted, the technology described herein may be used with any combination of one or more resource sites (e.g., multiple oil fields or multiple wellsites, etc.), one or more processing facilities, etc. As can be seen in FIG. 2, the resource site 200 may have data acquisition tools 202a, 2026, 202c, and 202d positioned at various locations within the resource site 200. The subterranean structure 204 may have a plurality of geological formations 206a-206d. As shown, this structure may have several formations or layers, including a shale layer 206a, a carbonate layer 206b, a shale layer 206c, and a sand layer 206d. A fault 207 may extend through the shale layer 206a and the carbonate layer 206b. The data acquisition tools, for example, may be adapted to take measurements and detect geophysical and/or geochemical characteristics of the various formations shown.

While a specific subterranean formation with specific geological structures is depicted, it is appreciated that the resource site 200 may contain a variety of geological structures and/or formations, sometimes having extreme complexity. In some locations of a given geological structure, for example below a water line relative to the given geological structure, fluid may occupy pore spaces of the formations. Each of the measurement devices (e.g., sensors) may be used to measure properties of the formations and/or other geological features. While each data acquisition tool is shown as being in specific locations in FIG. 2, it is appreciated that one or more types of measurement may be taken at one or more locations across one or more sources of the resource site 200 or other locations for comparison and/or analysis. The data collected from various sources at the resource site 200 may be processed and/or evaluated and/or used as training data, and or used to generate high resolution result sets for characterizing a resource at the resource site, and/or used for generating resource models, etc. In one embodiment, the data collected by one or more sensors at the resource site may include data associated with the number of wells of a first reservoir or second reservoir at the resource site, data associated with the number of grid cells of the first or second reservoir, data associated with the average permeability of the first or second reservoir, data associated with the production duration history (e.g., number of years of production) of the first reservoir or second, etc.

Data acquisition tool 202a is illustrated as a measurement truck, which may comprise devices or sensors that take measurements of the subsurface through sound vibrations such as, but not limited to, seismic measurements. Drilling tool 202b may include a downhole sensor adapted to perform logging while drilling (LWD) data collection. Wireline tool 202c may include a downhole sensor deployed in a wellbore or borehole. Production tool 202d may be deployed from a production unit or Christmas tree into a completed wellbore. Examples of parameters that may be measured include weight on bit, torque on bit, subterranean pressures (e.g., underground fluid pressure), temperatures, flow rates, compositions, rotary speed, particle count, voltages, currents, gamma ray data associated with the well at the resource site, resistivity data associated with the well at the resource site, density or porosity data associated with the well at the resource site, water saturation data associated with the well at the resource site, hydrocarbon saturation associated with the well at the resource site and/or other parameters associated with operations at the resource site.

Sensors may be positioned about the resource site 200 to collect data relating to various oil field operations, such as sensors deployed by the data acquisition tools 202. The sensors may include any type of sensor such as a metrology sensor (e.g., temperature, humidity), an automation enabling sensor, an operational sensor (e.g., pressure sensor, H₂S sensor, thermometer, depth, tension), evaluation sensors, that can be used for acquiring data regarding the geological formation, wellbore information, formation fluid/gas information, wellbore fluid information, data associated with gas/oil/water comprised in the formation/wellbore fluid, etc. For example, the sensors may include accelerometers, flow rate sensors, pressure transducers, electromagnetic sensors, acoustic sensors, temperature sensors, chemical agent detection sensors, nuclear sensor, and/or any additional suitable sensors. In one embodiment, the data captured by the one or sensors may be used to characterize, or otherwise generate one or more parameter values for a high resolution result set used to, for example, generate and/or configure a resource model and/or a transformer model. In other embodiments, test data or synthetic data may also be used in developing and/or configuring the resource model and/or the transformer model via one or more simulations and or testing operations.

Evaluation sensors may be featured in downhole tools such as tools 202b-202d and may include for instance electromagnetic, acoustic, nuclear, and optic sensors. Examples of tools including evaluation sensors that can be used in the framework of the current method include electromagnetic tools including imaging sensors such as FMI™ or QuantaGeo™ (mark of SLB, Houston, TX); induction sensors such as Rt Scanner™ (mark of SLB, Houston, TX), multifrequency dielectric dispersion sensor such as Dielectric Scanner™ (mark of SLB, Houston, TX); acoustic tools including sonic sensors, such as Sonic Scanner™ (mark of SLB, Houston, TX) or ultrasonic sensors, such as pulse-echo sensor as in UBI™ or PowerEcho™ (marks of SLB, Houston, TX) or flexural sensors PowerFlex™ (mark of SLB, Houston, TX); nuclear sensors such as Litho Scanner™ (mark of SLB, Houston, TX) or nuclear magnetic resonance sensors; fluid sampling tools including fluid analysis sensors such as InSitu Fluid Analyzer IM (mark of SLB, Houston, TX); distributed sensors including fiber optic. Such evaluation sensors may be used in particular for evaluating the formation in which the well is formed (i.e., determining petrophysical or geological properties of the formation), for verifying the integrity of the well (such as casing or cement properties) and/or analyzing the produced fluid (flow, type of fluid, etc.).

As shown, data acquisition tools 202a-202d may generate data plots or measurements 208a-208d, respectively. These data plots are depicted within the resource site 200 to demonstrate that data generated by some of the operations executed at the resource site 200.

Data plots 208a-208c are examples of static data plots that may be generated by data acquisition tools 202a-202c, respectively. However, it is herein contemplated that data plots 208a-208c may also be data plots that may be generated and updated in real time. These measurements may be analyzed to better define properties of the formation(s) and/or determine the accuracy of the measurements and/or check for and compensate for measurement errors. The plots of each of the respective measurements may be aligned and/or scaled for comparison and verification purposes. In some embodiments, base data associated with the plots may be incorporated into site planning, modeling a test at the resource site 200. The respective measurements that can be taken may be any of the above.

Other data may also be collected, such as historical data of the resource site 200 and/or sites similar to the resource site 200, user inputs, information (e.g., economic information) associated with the resource site 200 and/or sites similar to the resource site 200, and/or other measurement data and other parameters of interest. Similar measurements may also be used to measure changes in formation aspects over time.

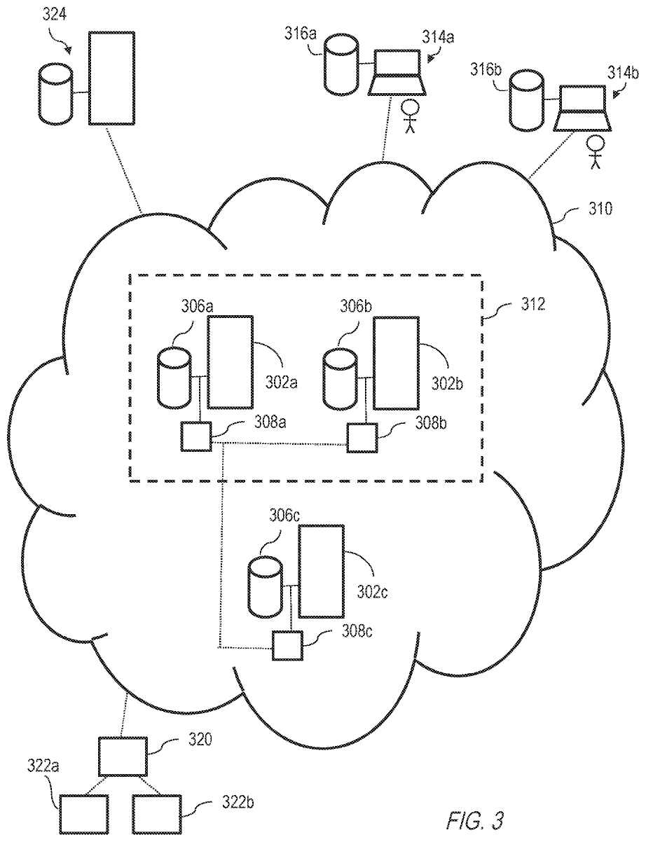

Computer facilities such as those discussed in association with FIG. 3 may be positioned at various locations about the resource site 200 (e.g., a surface unit) and/or at remote locations relative to the resource site 200. A surface unit (e.g., one or more terminals 320) may be used to communicate with the onsite tools and/or offsite operations, as well as with other surface or downhole sensors. The surface unit may be capable of sending commands to the oil field equipment/systems, and receiving data therefrom. The surface unit may also collect data generated during production operations and can produce output data, which may be stored or transmitted for further processing.

The data collected by sensors may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis or for modeling purposes to optimize production processes at the resource site 200. In one embodiment, the data is stored in separate databases, or combined into a single database.

### High-Level Network System

FIG. 3 shows a high-level network system 300 indicating a communicative coupling of devices or systems associated with the resource site 200 as described in FIG. 2. The system shown in the figure may include a set of processors 302a, 302b, and 302c for executing one or more processes discussed herein. The set of processors 302 may be electrically coupled to one or more servers (e.g., computing systems) including memory 306a, 306b, and 306c that may store for example, program data, databases, and other forms of data. Each server of the one or more servers may also include one or more communication devices 308a, 308b, and 308c. The set of servers may provide a cloud-computing platform 310. In one embodiment, the set of servers includes different computing devices that are situated in different locations and may be scalable based on the needs and workflows associated with the resource site 200. The communication devices of each server may enable the servers to communicate with each other through a local or global network such as an Internet network. In some embodiments, the servers may be arranged as a town 312, which may provide a private or local cloud service for users. A town may be advantageous in remote locations with poor connectivity. Additionally, a town may be beneficial in scenarios with large networks where security may be of concern. A town in such large network embodiments can facilitate implementation of a private network within such large networks. The town may interface with other towns or a larger cloud network, which may also communicate over public communication links. Note that cloud-computing platform 310 may include a private network and/or portions of public networks. In some cases, a cloud-computing platform 310 may include remote storage and/or other application processing capabilities.

The system of FIG. 3 may also include one or more user terminals 314a and 314b each including at least a processor to execute programs, a memory (e.g., 316a and 316b) for storing data, a communication device and one or more user interfaces and devices that enable the user to receive, view, and transmit information. In one embodiment, the user terminals 314a and 314b is a computing system having interfaces and devices including keyboards, touchscreens, display screens, speakers, microphones, a mouse, styluses, etc. The user terminals 314 may be wirelessly coupled or coupled with wires to the one or more servers of the cloud-computing platform 310. The user terminals 314 may be client terminals or expert terminals, enabling collaboration between clients and experts through the system of FIG. 3.

The system of FIG. 3 may also include at least one or more resource sites 200 having, for example, a set of terminals 320, each including at least a processor, a memory, and a communication device for communicating with other devices wirelessly coupled or coupled with wires to the cloud-computing platform 310. The resource site 200 of FIG. 2 may also have one or more sensors (e.g., one or more sensors described in association with FIG. 2) or sensor interfaces 322a and 322b wirelessly coupled or coupled with wires to the set of terminals 320 and/or directly coupled to the cloud-computing platform 310. In some embodiments, data collected by the one or more sensors/sensor interfaces 322a and 322b may be processed to generate a one or more resource models (e.g., reservoir models) or one or more resolved datasets used to generate the resource model which may be displayed on a user interface associated with the set of terminals 320, and/or displayed on user interfaces associated with the set of servers of the cloud computing platform 310, and/or displayed on user interfaces of the user terminals 314. Furthermore, various equipment/devices discussed in association with the resource site 200 (as described in FIG. 2) may also wirelessly communicate with the set of terminals 320 and or coupled via wires directly to the cloud-computing platform 310. The equipment and sensors may also include one or more communication device(s) that may communicate with the set of terminals 320 to receive orders/instructions locally and/or remotely from the resource site 200 and also send statuses/updates to other terminals such as the user terminals 314.

The system of FIG. 3 may also include one or more client servers 324 including a processor, memory and communication device. For communication purposes, the client servers 324 may be wirelessly coupled or coupled with wires to the cloud-computing platform 310, and/or to the user terminals 314a and 314b, and/or to the set of terminals 320 at the resource site 200 and/or to sensors at the oil field, and/or to other equipment at the resource site 200.

A processor, as discussed with reference to the system of FIG. 3, may include a microprocessor, a graphical processing unit (GPU), a microcontroller, a processor module or subsystem, a programmable integrated circuit, a programmable gate array, or another control or computing device.

The memory/storage media discussed above in association with FIG. 3 can be implemented as one or more computer-readable or machine-readable storage media that are non-transitory. In some embodiments, storage media may be distributed within and/or across multiple internal and/or external enclosures of a computing system and/or additional computing systems. Storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs), BluRays or any other type of optical media; or other types of storage devices. “Non-transitory” computer readable medium refers to the medium itself (i.e., tangible, not a signal) and not data storage persistency (e.g., RAM vs. ROM).

Note that instructions can be provided on one computer-readable or machine-readable storage medium, or alternatively, can be provided on multiple computer-readable or machine-readable storage media distributed in a large system having possibly plural nodes and/or non-transitory storage means. Such computer-readable or machine-readable storage medium or media is (are) considered to be part of an article (or article of manufacture). The storage medium or media can be located either in a computer system running the machine-readable instructions, or located at a remote site from which machine-readable instructions can be downloaded over a network for execution.

It is appreciated that the described system of FIG. 3 is an example that may have more or fewer components than shown, may combine additional components, and/or may have a different configuration or arrangement of the components. The various components shown may be implemented in hardware, software, or a combination of both, hardware and software, including one or more signal processing engines and/or application specific integrated circuits.

Further, the steps in the flowchart described below may be implemented by running one or more functional modules in an information processing apparatus such as general-purpose processors or application specific chips, such as ASICs, FPGAs, PLDs, GPUs or other appropriate devices associated with the system of FIG. 3. For example, the flowchart of FIG. 1 as well as the flowchart below may be executed using a signal processing engine stored in memory 306a, 306b, or 306c such that the signal processing engine includes instructions that are executed by the one or more processors such as processors 302a, 302b, or 302c as the case may be. The various modules of FIG. 3, combinations of these modules, and/or their combination with general hardware are included within the scope of protection of the disclosure. While one or more computing processors (e.g., processors 302a, 302b, or 302c) may be described as executing steps associated with one or more of the flowcharts described in this disclosure, the one or more computing device processors may be associated with the cloud-based computing platform 310 and may be located at one location or distributed across multiple locations. In one embodiment, the one or more computing device processors may also be associated with other systems of FIG. 3 other than the cloud-computing platform 310.

In some embodiments, a computing system is provided that includes at least one processor, at least one memory, and one or more programs stored in the at least one memory, such that the programs comprise instructions, which when executed by the at least one processor, are configured to perform any method disclosed herein.

In some embodiments, a computer readable storage medium is provided, which has stored therein one or more programs, the one or more programs including instructions, which when executed by a processor, cause the processor to perform any method disclosed herein. In some embodiments, a computing system is provided that includes at least one processor, at least one memory, and one or more programs stored in the at least one memory for performing any method disclosed herein. In some embodiments, an information processing apparatus for use in a computing system is provided for performing any method disclosed herein.

### EMBODIMENTS

The present disclosure is directed to methods, systems, and computer programs that automatically separate geological markers derived from wellbore data, generate visualizations based on said separated geological markers, and initiate one or more control operations associated with a resource site. According to some embodiments, the methods comprise generating a transformer model using the wellbore data. The transformer model, in some implementations, may comprise a model (e.g., a machine learning or artificial intelligence model) that is configured to predict data values (e.g., filtered or windowed data values) associated with a windowed dataset comprising a multivariate input signal. The multivariate input signal, according to one embodiment, can comprise a multivariate time series data such as gamma ray data, resistivity data, density data, conductivity data, density data, porosity data, permeability data, water saturation data, hydrocarbon saturation data, etc., captured using one or more sensors deployed about a well or associated with a borehole at a resource site.

In addition, the method may comprise applying the multivariate input signal to the transformer model. For example, the multivariate input signal may comprise multivariate time series windowed data derived from measurements (e.g., marker measurements obtained from a well) that are applied or otherwise ingested as input to the transformer model. According to some implementations, the transformer model may generate, based on the ingested multivariate input signal, latent space representations of each geological marker associated with the transformer model. In some cases, the latent space representation exemplifies a data representation indicative of a bottleneck layer or an intermediate layer of the transformer model for well logs which encodes marker or welltop information succinctly to facilitate easily identifying geological markers for well log data. In particular, this representation seamlessly helps to distinguish different kinds of geological marker signatures under varying geological conditions. As such similar geological markers can appear very close to each other (e.g., in terms of cosine distance) in the bottleneck layer or the latent space representation than in the original or raw signals (e.g., raw well log data).

According to one embodiment, the clustering operations disclosed may comprise a k-means clustering operation or quantization operation where a set of geological marker signatures are partitioned into k clusters in which each geological marker belongs to the cluster with the nearest mean value. In some embodiments, the clustering operation disclosed comprises one or more probabilistic clustering operations that may or may not include a trained machine learning model or artificial intelligence engine that drives the clustering operation.

Moreover, dimensionality data of the transformer model may be minimized or otherwise reduced to provision low dimensional representations of the latent space representations of each marker time series data. Additionally, the reduced dimensionality data may be clustered as further discussed below.

It is appreciated that given a set of geological markers picked or associated with a plurality of wells (e.g., different wells at a given resource site), all geological markers having similar properties (e.g., gamma radiation (e.g., natural gamma radiation) property, conductivity property, density property, porosity property, permeability property, resistivity property, etc.), may be clustered for generating a clustered data visualization. Additionally, marker clusters that are distinct (e.g., having different properties) may be separated from each other. In some embodiments, a geological marker when annotated may be named differently (e.g., Team A names a geological marker M1, team B names the same geological marker M2). In such scenarios, geological markers M1 and M2 may be recognized as one geological marker (e.g., marker M) when visualized with the disclosed automatic marker separation solution.

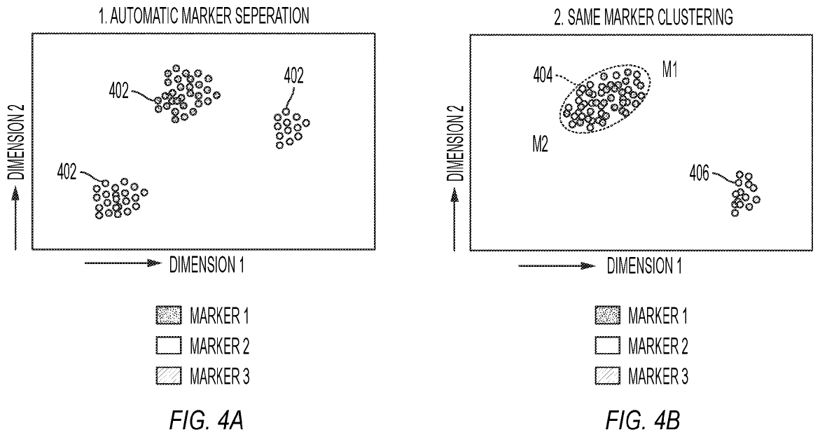

For example, FIGS. 4A and 4B provide exemplary visualizations of clustered geological markers. In FIG. 4A, a transformer model may be used to generate a plurality of geological markers 402 (e.g., Marker 1, Marker 2, and Marker 3). In response to generating the plurality of geological markers, a clustering operation may be used to group or otherwise aggregate geological markers with similar properties as shown in FIG. 4B. The clustering operation may include a cosine distance measure that can be implemented to compute a distance between lower dimensional features associated with geological markers 402 or compute a distance between features of the data elements associated with the one or more geological markers. As seen in the FIG. 4B, Markers 1 and 2 are aggregated together to form an aggregate marker 404 since they share similar properties that are different from Marker 3 (e.g., geological marker 406). These aspects are further discussed below.

According to some implementations, a marker time series series window W[n] may be created for well log data captured by one or more sensors deployed in a borehole of a well. The well log data may comprise a multivariate time series of measurements such as gamma ray/gamma radiation data, resistivity data, density data, conductivity data, density data, porosity data, permeability data, water saturation data, hydrocarbon saturation data, etc., associated with a one or more geological formations of the well as discussed above. In some embodiments, the marker time series window comprises a data construct or a data filter that selects particular data samples within the well log data while, according to some implementations, excluding other data samples or elements comprised in the well log data. For example, the marker time series window may be configured to have a length of 2N+1 samples. In one embodiment, N samples of the well log data may be selected prior to, or before a given marker depth, and N samples post said marker depth. Thus, W[n] may represent an nth time series window that is created.

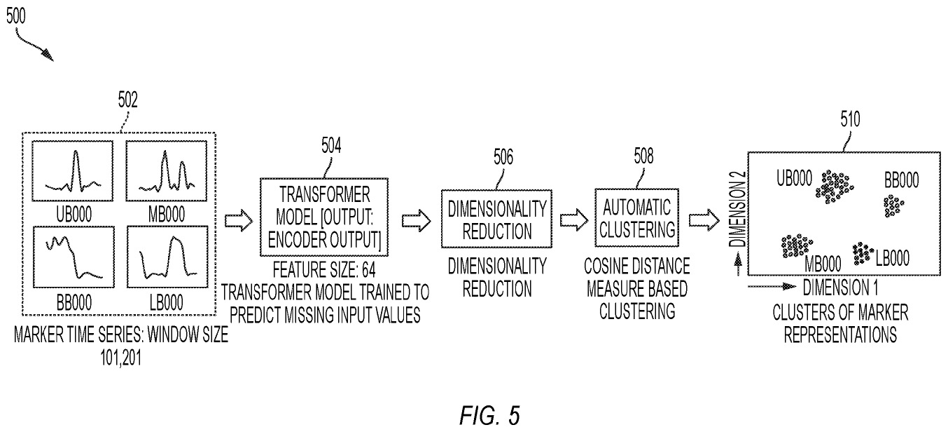

FIG. 5 provides an exemplary workflow 500 where a marker time series window is applied to well log data. In the illustrated implementation, windowed well log data may be generated, at block 502, by applying the marker time series window W[n] to the well log data. The windowed well log data may then be applied to a transformer model that is operable to predict or estimate marker values within the well log data. The transformer model (e.g., model T) may be trained or otherwise configured in advance to predict masked or windowed values comprised in the time series input window. More specifically, the windowed well log data may be applied, at block 504, as input to the transformer model. Instead of directly processing the output of transformer model, the windowed output data from an encoder of transformer model may be used instead. This windowed output data may be referred to herein as a latent space representation T_{E}[n] of the input time series.

In some instances, a dimension of the latent space representation T_{E}[n] may be reduced, at block 506, to optimize storage and/or further processing of well log data. For example, a dimensionality reduction process may be used to reduce the latent space representation T_{E}[n] from a first dimensional space (e.g., a high dimensional space such as a 2-dimensional space or a 3 dimensional space) to a second dimensional space (e.g., low dimensional space such as a 1-dimensional space). The reduced latent space representation T_{E}[n] may be used to generate visualizations that indicate or visualize patterns of marker clustering(s) of the latent space representation T_{E}[n]. For example, the latent space representation T_{E}[n] for wells in a given basin may be provided as input to a dimensionality reduction process such that for each latent space representation T_{E}[n], a lower dimensional space (e.g., 1 dimensional space) representation U[n] may be generated as output of after the dimensionality reduction process.

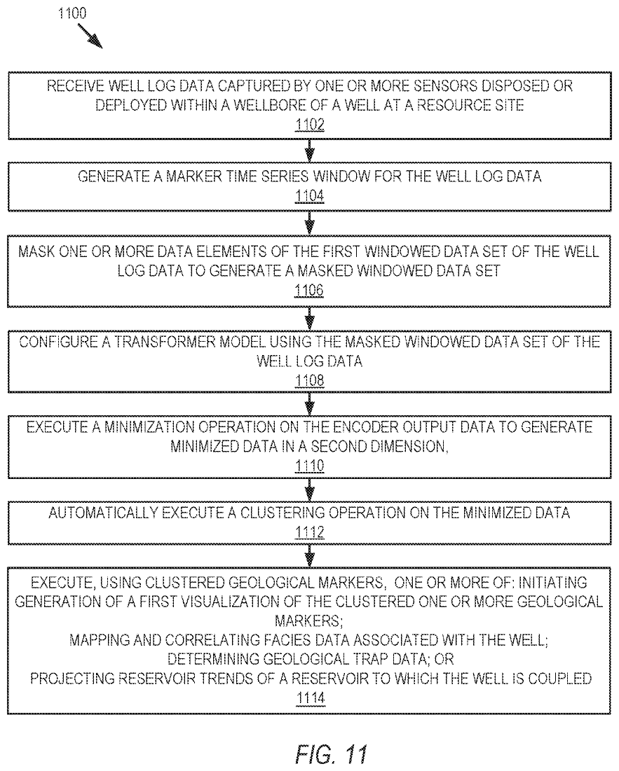

It is appreciated that the illustrated implementation of FIG. 5 provides an exemplary instance where a marker time series window is applied to well log data UB000, MB000, BB000, and LB000, and where the well log data is indexed based on index parameters or properties including: measured depth (MD), true vertical depth subsea (TVDSS), true stratigraphic depth (TST), two-way time (TWT), or some other depth or time index parameter. The windowed data is then applied to a data encoder of the transformer model. The output of the transformer model is then dimensionally reduced following which an automatic clustering process is executed, at block 508, on the dimensionally reduced data. In particular, the output of the transformer model may be dimensionally reduced, following which an automatic clustering process is executed on the dimensionally reduced data. For example, the automatic clustering process may be based on cosine distance measure that computes the distance between lower dimensional features of the dimensionally reduced data. These aspects are further discussed in association with the flowchart 1100 of FIG. 11 below.

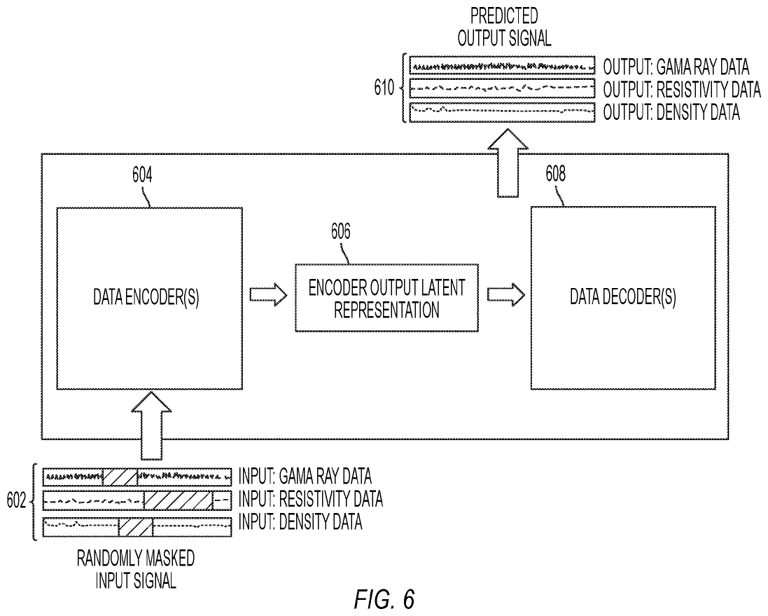

As previously noted, the transformer model may be trained to predict or otherwise estimate masked or obscured time series values in the input marker time series window W[n] as further discussed in association with FIG. 6. For example, the transformer model may ingest training data including one or more of: masked gamma ray data, masked resistivity data, or masked density data that are comprised in the time series measurements captured by one or more sensors deployed within a well or borehole. In particular, the transformer model is trained or otherwise configured in, for example, one or more simulations to predict the missing/masked values at the output as shown in FIG. 6. More specifically, masked input 602 may be applied to a data encoder 604 of the transformer model to configure or train the transformer model and thereby generate encoder output data indicating a latent representation 606 of the masked input 602. The masked input, for example, may comprise a multivariate input signal (e.g., gamma ray data, resistivity data, or density data) that is randomly masked. As the masked values (e.g., training data) are known a posteriori (e.g., known from observation or from measurements), a ground truth output signal 610 may be generated using this knowledge after using a data decoder 608 of the transformer model to decode the latent representation 606 generated by the data encoder 604. Thus, the input-output mapping for configuring the transformer model may leverage data samples associated with the input signal to configure the transformer model in a self-supervised manner. The transformer model thus trained, learns a hierarchy of features for the input signal (e.g., gamma ray data, resistivity data, or density data).

As noted above, the transformer model may be configured to predict masked values in the input signal (e.g., windowed dataset of the well log data) or the training dataset. The training dataset can be generated using a plurality of well log data to configure the transformer model. In some instances, the training dataset is based on a training input signal (e.g., masked windowed dataset) and a ground truth signal (e.g., dataset corresponding to the windowed dataset without the masking). For example, the training input signal may include the input signal W[n] created by taking random 2N+1 samples from the well logs. A masking operation (e.g., random masking operation) may be applied to, for example, X samples associated with density data, Y samples associated with resistivity data, and Z samples associated with gamma ray data comprised in the captured well log data. In some embodiments, the masking operation may be based on a token or numerical value (e.g., token ‘Z+’, where Z+ represents a positive integer) indicative of one or more weights associated with one or more layers of the transformer model. Since the masked values are already known, the ground truth signal may be created by unmasking the masked values. Referencing the ground truth signal or ground truth data as G[n], an input-output mapping for the training dataset W[n] may be determined as further discussed below.

During training of the transformer model, an input signal (e.g., W[n] samples of the well log dataset) may be applied to the input of the transformer model. This signal propagates through the data encoder of the transformer model. At the output of the data encoder, the signal represents a latent space representation as noted above in association with FIG. 6. The signal then propagates through a data decoder of the transformer model to generate a decoder output signal or decoder output data. According to some implementations, previous decoder output data may be fed back as input to the data decoder along with the current encoder output data. In the initial stages of configuring the transformer model, when W[n] (with multiple values masked) is applied to the input of the transformer model, the decoder output data appears to be different relative to W[n]. Referencing the decoder output data as O[n], an error signal given by E[n] may be computed using the following relationship:

$$E [ n ] = G [ n ] - O [ n ] ,$$

where G[n] is the ground truth data,
O[n] is the decoder output data, and
   E[n] is the error signal.

This error signal may be back-propagated through one or more layers of the transformer model to update configure, or otherwise optimize one or more weights of the layers of the transformer model so that the output signal O[n] comes closer to the ground truth signal and thereby enhance the accuracy of the transformer model. After multiple simulation iterations that involve presenting or applying a plurality of training data inputs (e.g., hundreds and thousands of training data inputs) to the transformer model and back-propagating the error signal E[n] through the layers of the transformer model and simultaneously updating weights associated with the layers of the transformer model, the transformer model begins to reconstruct the masked values in the input signal accurately. This means that that the output data O(n) is substantially close or approximate to G (n) after multiple epochs of training. As the transformer model learns to accurately predict or estimate the missing/masked input values, it implicitly learns to distinguish between subtle differences in the input time series windowed data.

The latent space representation of the input time series window can also be interpreted as an embedding that represents the input time series window. The embedding in this context refers to a lower dimensional representation of data comprised in the time series window of the input signal, which can correspond to a real-valued vector that encodes high-level features comprised in the well log data. Also, as this embedding can represent the input multivariate time series window, it provides a reference signature for the well log markers that indicate changes in geological layers associated with one or more wells. The transformer latent space-based embedding for the same geological marker picked from different wells may be similar and may be clustered together when plotted. Also, these embeddings for distinct geological markers may be different and form clusters that are well separated, according to some embodiments.

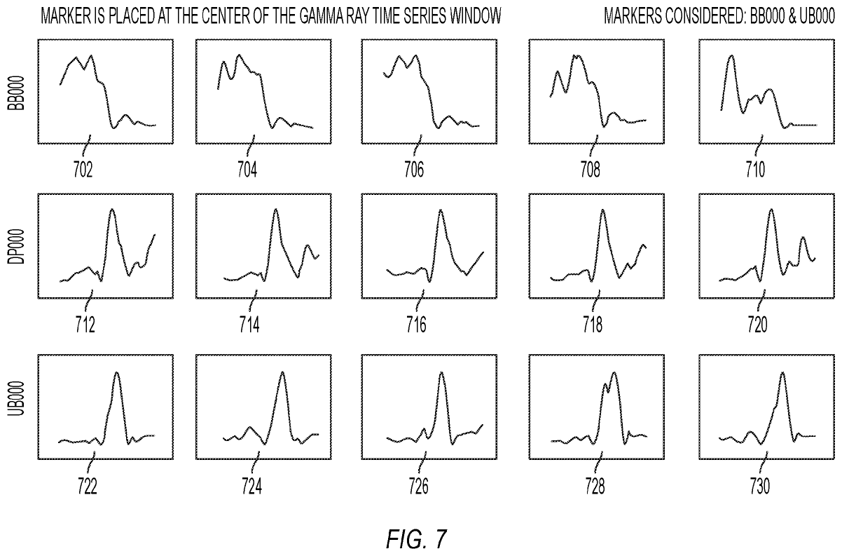

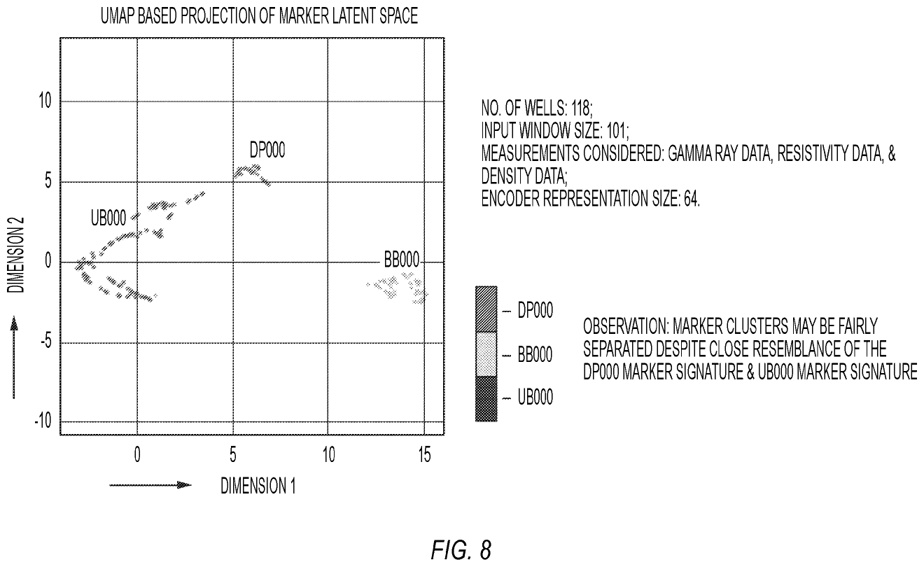

The transformer latent space-based representation of geological markers and subsequent dimensionality reduction approach, followed by automatic clustering of geological markers results in clear separation of marker clusters. In particular, the proposed approach may be used to obtain automatic marker separation for datasets with one or more markers. The below described examples are for a Bakken dataset or another second dataset, but are in no way limiting for the disclosed methods and systems for automatic marker separation. For example, and as described below in FIGS. 7-8, the proposed approach can be used to get automatic marker separation for a first dataset (e.g., a Bakken dataset) with markers including BB000, DP000, and UB000. For example, the marker data associated with the BB000 marker include captured data 702-710. Similarly, the marker data associated with the DP000 marker include captured data 712-720 while the marker data associated with the UB000 marker include data elements 722-730.

Turning back to the geological marker data indicated in FIG. 7, it is appreciated that the geological markers selected for automatic separation based on the disclosed techniques are—BB000, DP000, and UB000. In particular, the first dataset represents a well log dataset obtained from a resource site (e.g., a resource site called Bakken) such that welltops, which may also be referred to as geological markers at the resource site may be given arbitrary names such as BB000, DP000, and UB000, etc. by geologists. The time series representative signatures for geological markers dataset are represented in FIG. 7 as 702-730. The present disclosure is not limited to characterizing the time series representative signatures shown in FIG. 7. Rather, the disclosed approach is equally applicable to other time series representations as further discussed below.

Furthermore, automatic clustering of geological markers for the dataset of FIG. 7 are provided in FIG. 8. In particular, each dot on the plots shown in FIG. 8 represents a geological marker or welltop. The present disclosure is not limited to the plots presented in just FIG. 8. Rather, the disclosed techniques can be used to generate other visualized marker clustering as further discussed below.

In the exemplary depiction of FIG. 8, the welltops or geological markers may initially have a length of 201 samples. In the transformer latent space representation, 64 vector values may be used to represent the 201 sample welltops after processing via the transformer model. A Uniform Manifold Approximation and Projection (UMAP) operation may be applied on the generated vector values to render the 2-dimensional visualization shown in FIG. 8. In addition, it is appreciated that the welltops UB000 form a distinct cluster that is separate from the welltops DP000 and BB000 which are similarly distinct relative to each other. This means that similar welltops are plotted close together while distinct welltops are distally placed relative to each other on this map. In other words, distinct plots are easily separable using the automated clustering techniques discussed herein.

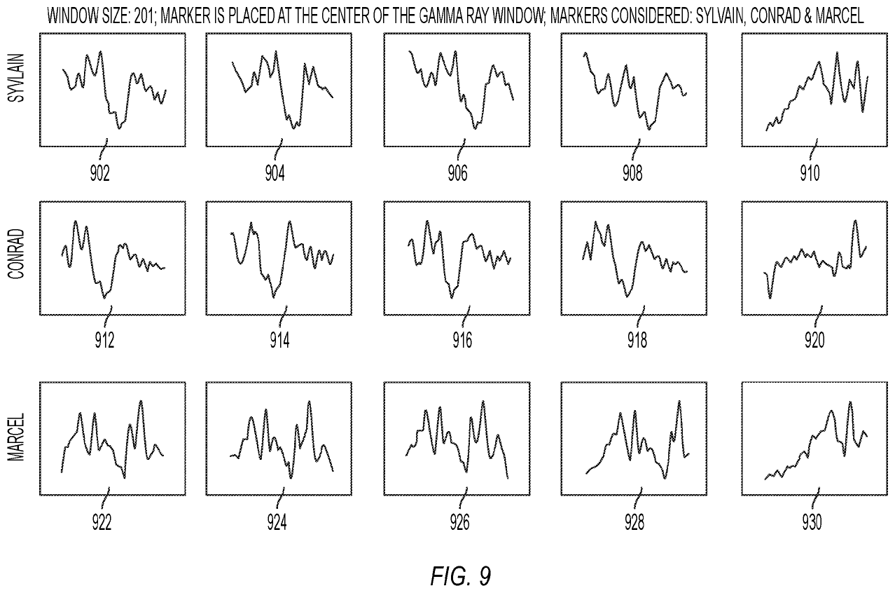

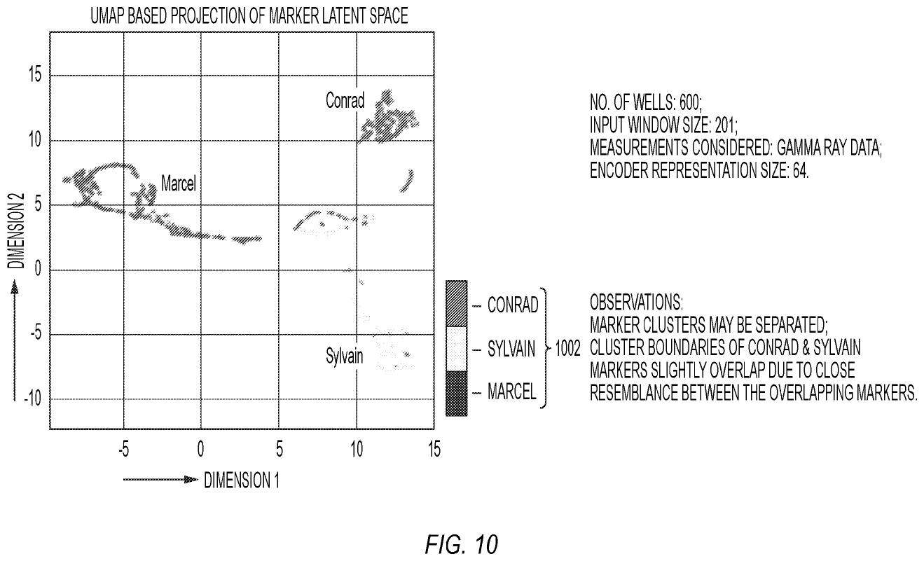

In another example, and as described in association with FIGS. 9-10, the proposed approach can be used to achieve automatic marker separation for a second dataset with corresponding markers. In particular, FIG. 9 shows the time series representative signatures (e.g., gamma ray data) for a second dataset associated with the geological markers or marker signatures called Sylvain, Conrad, and Marcel. In one embodiment, the marker signatures indicate time series data for a geological marker. Furthermore, a given marker signature, as disclosed, can depict a multi-dimensional visual representation of time series data for a geological marker with, for example, sample numbers in one dimension (e.g., x-axis or first dimension) and geological parameter data (e.g., gamma ray data) in another dimension (e.g., y-axis or second dimension).

Automatic clustering of the geological markers associated with the second dataset marker signatures of FIG. 9 are provided in FIG. 10. In particular, FIG. 10 depicts automatic clustering of the set of markers from the exemplary dataset of FIG. 9. Similar to FIG. 8, various marker signatures of FIG. 9 are clustered together and may be interpreted using the clustering legend 1002.

It is appreciated that the disclosed approach is not limited to just the first dataset or second dataset discussed above. In particular, the disclosed methods, systems, and computer programs can be applied to, or otherwise used for clustering marker signatures of a third dataset, a fourth dataset, a fifth dataset, a sixth dataset, etc., all of which may or may not be associated with a plurality of resource sites such as those described herein. For example, the disclosed approach may be applied to clustering marker signatures of other datasets such as the North Sea dataset derived from geographic information systems that capture geological data from the North Sea geographical region.

It is further appreciated that the disclosed techniques leverage a probabilistic methodology to cluster marker signatures and thereby determine a probability of assignment of each welltop or geological marker event to specific clusters of marker signatures. For example, in response to determining one or more marker clusters using the disclosed methods, systems, and computer programs, one or more welltops may be identified which have associated specific marker signature data that facilitate probabilistically linking the welltops to the clustered marker signatures.

### Exemplary Workflow

FIG. 11 provides an exemplary detailed workflow 1100 for methods, systems, and computer programs that automatically separate geological markers associated with well log data. It is appreciated that a signal processing engine stored in a memory device may cause a computer processor to execute the various processing stages of the workflows discussed herein. For example, the disclosed techniques may be implemented as signal processing engine within a geological software tool such that the signal processing engine enables automatically separating geological markers associated with well log data based on the processes outlined herein.

At block 1102, the signal processing engine receives well log data captured by one or more sensors disposed or deployed within a wellbore of a well at a resource site. The well log data may be indexed using index parameters including: measured depth (MD) index, true vertical depth subsea (TVDSS) index, true stratigraphic depth (TST) index, two way time (TWT) index, or other depth or time index as further discussed below. In one embodiment, the well log data includes measurements indicating one or more geological parameters.

At block 1104, the signal processing engine generates a marker time series window for the well log data. The marker time series window may be applied to select one or more data samples within the well log data, where the well log data may be indexed based on one or more of the index parameters (e.g., measured depth (MD) index, true vertical depth subsea (TVDSS) index, true stratigraphic depth (TST) index, two way time (TWT) index, or other depth or time index provided herein, to generate a first windowed dataset of the well log data. To reiterate, the data samples of the well log data can be represented using different indices: sample number index, MD index, TVDSS index, TST index, TWT index, or other depth or time index provided herein, and depending on the chosen index, the log signature may be slightly different (e.g., the signal may be stretched/squeezed as a result of switching indices), which will in turn have an impact on the predicted output data (e.g., some indices will be more geologically “correct”).

At block 1106, the signal processing engine blocks or masks one or more data elements of the first windowed dataset of the well log data to generate a masked windowed dataset, such that the one or more data elements of the first windowed dataset comprise data elements in a first dimension (e.g., a first dimensional space).

At block 1108, the signal processing engine may be used to configure a transformer model using the masked windowed dataset of the well log data. According to some embodiments, configuring the transformer model comprises applying as input to a data encoder of the transformer model the masked windowed dataset, and predicting at least one data value associated with the masked windowed dataset using the transformer model.

At block 1110, in response to generating encoder output data based on applying a second windowed dataset to the data encoder of the transformer model, the signal processing engine executes a minimization operation on the encoder output data to generate minimized data in a second dimension, such that the second dimension is of a lower order relative to a third dimension of the second windowed dataset. Moreover, the minimized data includes a plurality of geological markers. As used herein, a geological marker comprises marked depths associated with well log data that indicate geological layers of a geological formation associated with a well.

At block 1112, the signal processing engine automatically executes a clustering operation on the minimized data. The clustering operation may include aggregating together, one or more geological markers comprised in the plurality of geological markers.

Based on the clustering, the signal processing engine executes, at block 1114, one or more of: initiating generation of a first visualization of the clustered one or more geological markers on a display device for viewing by a user, the first visualization indicating space-time structural transitions of a geological formation associated with the well; mapping and correlating facies data that indicate sedimentary structure data, fossil data, or other geological associations of the geological formation associated with the well; determining geological trap data that indicate a sealed geologic container of the geological formation that holds fluid and which is associated with the well; or projecting reservoir trends of a reservoir to which the well is connected or otherwise. These results inform control operations such as drilling, pumping, and installing exploration equipment at the resource site.

These and other implementations may each optionally include one or more of the following features. The transformer model includes at least one of: a data encoder that receives the masked windowed dataset of the well log data; and a data decoder that translates outputs of the data encoder into estimated values of the one or data elements.

In one embodiment, the geological parameters may include one or more of: gamma ray data associated with the well at the resource site; resistivity data associated with the well at the resource site; density or porosity data associated with the well at the resource site; water saturation data associated with the well at the resource site; and hydrocarbon saturation associated with the well at the resource site.

Moreover, the encoder output data comprises a latent representation of the masked windowed dataset of the well log data.

Furthermore, the marker time series window may be selected based on geological properties of the geological formation associated with the well.

According to some implementations, the minimizing operation may be executed using a cosine distance measure process that computes a distance between features of the data elements associated with the one or more geological markers. Other exemplary minimization processes contemplated include a Euclidean distance minimization processes, a Manhattan distance minimization processes, an Absolute Error minimization processes, etc.

In addition, the geological trap data discussed in association with the method 1100 of FIG. 11 comprises one of: structural trap data, or stratigraphic trap data.

Additionally, the one or more geological markers that are aggregated together have similar geological properties including rock structure properties and/or other petro-physical properties associated with a geological formation.

Moreover, the method 1100 of FIG. 11 may further comprise using the signal processing engine to execute one or more of: applying as input to the data encoder of the transformer model, a plurality of windowed datasets from a plurality of well log data associated with a plurality of wells to generate a plurality of encoder output data; and executing a plurality of minimization operations on the plurality of encoder output data to generate a plurality of minimized data. The signal processing engine may be further used to automatically execute a clustering operation on the plurality of minimized data, the clustering operation including aggregating together a plurality of geological markers: associated with the plurality of minimized data; and that have similar geological properties together. Moreover, the signal processing engine may be further used to execute one or more of: initiating generation of a second visualization of the clustered plurality of geological markers on a display device for viewing by a user, the second visualization indicating space-time structural transitions of one or more geological formations associated with a plurality of wells. The signal processing engine may also be used to map and correlate facies data that indicate sedimentary structure data, fossil data, and geological associations of the one or more geological formations associated with the plurality of wells. In addition, the signal processing engine may also be used to determine geological trap data that indicate one or more sealed geologic containers of the one or more geological formations that hold fluid and are associated with the plurality of wells. In some cases, the signal processing engine is used to project reservoir trends of one or more reservoirs to which the plurality of wells are connected.

In exemplary implementations, the one or more data samples of the well log data is represented in, or characterized by an index or an index parameter indicating one or more of: a sample number index, a measured depth index, a true vertical depth subsea index, a true stratigraphic depth index, a two way time index, an index associated with the wellbore, or an index associated with a subsurface geometry model.

The disclosed methods and systems beneficially facilitate automatically clustering together similar geological markers associated with a plurality of wells in a map (e.g., visualization), a process which is rather infeasible and error prone when processing thousands of samples of wellbore data from a plurality of wells. Another benefit is that the clusters of distinct geological markers are separable to more clearly delineate between one or more geological markers associated with a given resource site. In addition, the disclosed techniques automate mapping of consistent stratigraphic events (e.g., welltop or geological marker events) across all interpretations (e.g., multiple areas of expertise in the geological space) and wells in a basin. Furthermore, the disclosed technology provides assessment of match accuracy in terms of probability of a match between a sequential data window to a particular welltop/geological marker cluster.

While any discussion of or citation to related art in this disclosure may or may not include some prior art references, Applicant neither concedes nor acquiesces to the position that any given reference is prior art or analogous prior art.

The foregoing description, for purpose of explanation, has been described with reference to specific embodiments. However, the illustrative discussions above are not intended to be exhaustive or to limit the disclosed solution to the precise forms disclosed. Many modifications and variations are possible in view of the above teachings. The embodiments were chosen and described in order to explain the principles of this disclosure and its practical applications, to thereby enable others skilled in the art to use the principles herein and various embodiments with various modifications as are suited to the particular use contemplated.

It is appreciated that the term optimize/optimal and its variants (e.g., efficient or optimally) may simply indicate improving, rather than the ultimate form of ‘perfection’ or the like

It is appreciated that, although the terms first, second, etc., may be used herein to describe various elements, these elements should not be limited by these terms. These terms are used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered the same object or step.

The terminology used in the description herein is for the purpose of describing particular embodiments and is not intended to be limiting. As used in the description of the disclosed techniques and the appended claims, the singular forms “a,” “an” and “the” are intended to include the plural forms as well, unless the context clearly indicates otherwise. It will also be understood that the term “and/or” as used herein refers to and encompasses any possible combination of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context.

Those with skill in the art will appreciate that while some terms in this disclosure may refer to absolutes, e.g., all source receiver traces, each of a plurality of objects, etc., the methods and techniques disclosed herein may also be performed on fewer than all of a given thing, e.g., performed on one or more components and/or performed on one or more source receiver traces. Accordingly, in instances in the disclosure where an absolute is used, the disclosure may also be interpreted to be referring to a subset.

What is claimed is:

1. A method for automatically separating geological markers associated with well log data, the method comprising:
receiving well log data captured by one or more sensors disposed within a wellbore of a well at a resource site;
generating a marker time series window for the well log data, the marker time series window being applied to select one or more data samples within the well log data to generate a first windowed dataset of the well log data;
masking one or more data elements of the first windowed dataset of the well log data to generate a masked windowed dataset, such that the one or more data elements of the first windowed dataset comprise data elements in a first dimension;
configuring a transformer model using the masked windowed dataset of the well log data;
in response to generating encoder output data based on applying a second windowed dataset to the data encoder of the transformer model, executing a minimization operation on the encoder output data to generate minimized data in a second dimension;
automatically executing a clustering operation on the minimized data, the clustering operation including aggregating together, one or more geological markers comprised in the plurality of geological markers.

2. The method of claim 1, wherein the transformer model includes at least one of:
a data encoder that receives the masked windowed dataset of the well log data; and
a data decoder that translates outputs of the data encoder into estimated values of the one or data elements.

3. The method of claim 1, wherein the well log data includes measurements indicating one or more geological parameters, wherein the geological parameters include one or more of:
gamma ray data associated with the well at the resource site;
resistivity data associated with the well at the resource site;
density or porosity data associated with the well at the resource site;
water saturation data associated with the well at the resource site; and
hydrocarbon saturation data associated with the well at the resource site.

4. The method of claim 1, wherein the encoder output data comprises a latent representation of the masked windowed dataset of the well log data.

5. The method of claim 1, wherein the marker time series window is selected based on geological properties of the geological formation associated with the well.

6. The method of claim 1, wherein the minimizing operation is executed using a cosine distance measure process that computes a distance between features of the data elements associated with the one or more geological markers.

7. The method of claim 1, wherein the geological trap data comprises one of:
structural trap data; or
stratigraphic trap data.

8. The method of claim 1, wherein the one or more geological markers that are aggregated together have similar geological properties.

9. The method of claim 1, comprising:
applying as input to the data encoder of the transformer model, a plurality of windowed datasets from a plurality of well log data associated with a plurality of wells to generate a plurality of encoder output data;
executing a plurality of minimization operations on the plurality of encoder output data to generate a plurality of minimized data;
automatically executing a clustering operation on the plurality of minimized data, the clustering operation including aggregating together a plurality of geological markers:
associated with the plurality of minimized data, and
that have similar geological properties;
executing, using the plurality of geological markers, one or more of:
initiating generation of a second visualization of the clustered plurality of geological markers on a display device for viewing by a user, the second visualization indicating space-time structural transitions of one or more geological formations associated with a plurality of wells,
mapping and correlating facies data that indicate sedimentary structure data, fossil data, and geological associations of the one or more geological formations associated with the plurality of wells,
determining geological trap data that indicate one or more sealed geologic containers of the one or more geological formations that hold fluid and are associated with the plurality of wells, or
projecting reservoir trends of one or more reservoirs to which the plurality of wells are connected.

10. The method of claim 9, wherein the one or more data samples of the well log data is represented in an index indicating one or more of:
a sample number index;
a measured depth index;
a true vertical depth subsea index;
a true stratigraphic depth index;
a two way time index;
an index associated with the wellbore; or
an index associated with a subsurface geometry model.

11. The method of claim 1, wherein configuring the transformer model using the masked windowed dataset of the well log data comprises:
applying as input to a data encoder of the transformer model the masked windowed dataset; and
predicting at least one data value associated with the masked windowed dataset using the transformer model.

12. The method of claim 1, wherein:
the second dimension is of a lower order relative to a third dimension of the second windowed dataset; and
the minimized data includes a plurality of geological markers.

13. The method of claim 1, further comprising executing, based on the clustered one or more geological markers, one or more of:
initiating generation of a first visualization of the clustered one or more geological markers on a display device for viewing by a user, the first visualization indicating space-time structural transitions of a geological formation associated with the well;
mapping and correlating facies data that indicate sedimentary structure data, fossil data, or geological associations of the geological formation associated with the well;
determining geological trap data that indicate a sealed geologic container of the geological formation that holds fluid and is associated with the well; or
projecting reservoir trends of a reservoir to which the well is connected.

14. A system for automatically separating geological markers associated with well log data, the system comprising:
a computer processor; and
memory storing instructions that are executable by the computer processor to:
receive well log data captured by one or more sensors disposed within a wellbore of a well at a resource site,
generate a marker time series window for the well log data, the marker time series window being applied to select one or more data samples within the well log data to generate a first windowed dataset of the well log data,
mask one or more data elements of the first windowed dataset of the well log data to generate a masked windowed dataset, such that the one or more data elements of the first windowed dataset comprise data elements in a first dimension,
configure a transformer model using the masked windowed dataset of the well log data,
execute a minimization operation on encoder output data to generate minimized data in a second dimension in response to generating the encoder output data based on applying a second windowed dataset to the data encoder of the transformer model, and
automatically execute a clustering operation on the minimized data, the clustering operation including aggregating together, one or more geological markers comprised in the plurality of geological markers.

15. The system of claim 14, wherein the geological parameters include one or more of:
gamma ray data associated with the well at the resource site;
resistivity data associated with the well at the resource site;
density or porosity data associated with the well at the resource site;
water saturation data associated with the well at the resource site; and
hydrocarbon saturation data associated with the well at the resource site.

16. The system of claim 14, wherein the encoder output data comprises a latent representation of the masked windowed dataset of the well log data.

17. The system of claim 14, wherein the marker time series window is selected based on geological properties of the geological formation associated with the well.

18. The system of claim 14, wherein the minimizing operation is executed using a cosine distance measure process that computes a distance between features of the data elements associated with the one or more geological markers.

19. The system of claim 14, wherein the memory stores instructions that are executable by the computer processor to:
apply as input to the data encoder of the transformer model, a plurality of windowed datasets from a plurality of well log data associated with a plurality of wells to generate a plurality of encoder output data;
execute a plurality of minimization operations on the plurality of encoder output data to generate a plurality of minimized data;
automatically execute a clustering operation on the plurality of minimized data, the clustering operation including aggregating together a plurality of geological markers:
associated with the plurality of minimized data, and
that have similar geological properties;
execute, using the plurality of geological markers, one or more of:
initiating generation of a second visualization of the clustered plurality of geological markers on a display device for viewing by a user, the second visualization indicating space-time structural transitions of one or more geological formations associated with a plurality of wells,
mapping and correlating facies data that indicate sedimentary structure data, fossil data, and geological associations of the one or more geological formations associated with the plurality of wells,
determining geological trap data that indicate one or more sealed geologic containers of the one or more geological formations that hold fluid and are associated with the plurality of wells, or
projecting reservoir trends of one or more reservoirs to which the plurality of wells are connected.

20. A computer program comprising instructions, that when executed by a computer processor of a computing device, causes the computing device to:
receive well log data captured by one or more sensors disposed within a wellbore of a well at a resource site;
generate a marker time series window for the well log data, the marker time series window being applied to select one or more data samples within the well log data to generate a first windowed dataset of the well log data;
mask one or more data elements of the first windowed dataset of the well log data to generate a masked windowed dataset, such that the one or more data elements of the first windowed dataset comprise data elements in a first dimension;
configure a transformer model using the masked windowed dataset of the well log data;
execute a minimization operation on the encoder output data to generate minimized data in a second dimension in response to generating encoder output data based on applying a second windowed dataset to the data encoder of the transformer model; and
automatically execute a clustering operation on the minimized data, the clustering operation including aggregating together, one or more geological markers comprised in the plurality of geological markers.
